(19) United States
(12) Patent Application Publication
(10) Pub. No.: US 2018/0293920 A1
(43) Pub. Date: Oct. 11, 2018

(54) Envelope for Interchangeable Display Inserts

(71) Applicant: Gary McCarthy, Fort Lauderdale, FL (US)

(72) Inventor: Gary McCarthy, Fort Lauderdale, FL (US)

(21) Appl. No.: 15/948,855

(22) Filed: Apr. 9, 2018

Related U.S. Application Data
(60) Provisional application No. 62/482,889, filed on Apr. 7, 2017.

(51) Int. Cl. G09F 7/18

(52) U.S. Cl. CPC G09F 7/18; G09F 2007/1865; G09F 2007/1852; G09F 2007/1843

(57) ABSTRACT

An envelope for interchangeable display inserts includes a front cover that is transparent and a back panel that is mountable to a desired surface. The front cover and the back panel are perimetrically connected to each other to form a pocket into which a display insert is positioned and displayed through the front cover. A non-affixed front edge of the front cover is aligned with a non-affixed back edge of the back panel to form an opening through which the display insert is positioned into the pocket. A flap is connected to the front cover along the non-affixed front edge, wherein the flap provides a means for securing the opening and the pocket closed. Preferably, the back panel is magnetic, wherein the back panel may be secured to a desired metal surface.

The current application claims a priority to the U.S. Provisional Patent application Ser. No. 62/482,889 filed on Apr. 7, 2017.

### FIELD OF THE INVENTION

The present invention relates generally to vehicle display items. More specifically, the present invention provides a means for securing interchangeable display inserts to a vehicle.

### BACKGROUND OF THE INVENTION

Bumper stickers are flexible devices which generally attach to the bumper of an automobile or similar device via adhesive connection. Bumper stickers display messages, symbols, and/or designs in order to add flair and style to whatever it is attached to. The problem with conventional bumper stickers is that they are difficult to remove post attachment. Due to this, inventors have developed magnetic bumper stickers which allow for easy removal and do not leave residue on the surfaces which they were previously connected to. Magnetic bumper stickers are also convenient as they allow users to quickly switch between selected displays. Even so, problems do exist, as individuals are generally required to purchase new bumper stickers when switching between them. This is not only expensive, but may also lead to buyer's remorse.

It is therefore an objective of the present invention to introduce a magnetic envelope for interchangeable display inserts. The present invention utilizes a rectangular magnetic panel and a clear panel made from a clear plastic film which covers the non-magnetic side of the magnet. All but one of the film's edges are affixed to corresponding edges of the magnet. The non-affixed edge forms an opening which leads into a space or pocket in between the film and non-magnetic side of the magnetic panel. Interchangeable display inserts may be placed inside the pocket in order to show a message, symbol, and/or other design through the film. The present invention acts as a magnetic envelope with a plastic cover that holds paper or other thin objects. The non-magnetic side of the magnetic panel can also be personalized to include branding of a company, a message, and/or other design that can be easily viewed through the film when no display insert is in use. Use of the present invention eliminates the need for users to buy new bumper stickers, as they only need to draw or print out a design on a sheet of paper, then insert it into the pocket. Use of the present invention will also promote organizations to provide images via email or website repository for easy access for print and display. Overall, the present invention is simple, easy to use, and cost effective.

### BRIEF DESCRIPTION OF THE DRAWINGS

FIG. 1 is a perspective view of the present invention in the preferred embodiment.

FIG. 2 is a perspective view of the present invention, wherein a display insert is aligned with the opening, to be inserted into the pocket.

FIG. 3 is a perspective view of the present invention, wherein the display insert is positioned within the pocket.

FIG. 4 is a front view of the present invention in the preferred embodiment.

FIG. 5 is a front view of the present invention, wherein the display insert is positioned within the pocket.

FIG. 6 is a front view of the present invention, wherein a display image is printed onto the inner surface of the back panel.

FIG. 7 is a rear view of the present invention in the preferred embodiment.

FIG. 8 is a front view of the back panel in the preferred embodiment.

FIG. 9 is a rear view of the back panel in the preferred embodiment.

FIG. 10 is a rear view of the present invention, wherein the flap is folded around the back panel to secure the opening and the pocket closed.

FIG. 11 is a perspective view of the present invention in an alternative embodiment, wherein the display insert is aligned with the opening.

FIG. 12 is a perspective view of the present invention in the alternative embodiment, wherein the display insert is positioned within the pocket.

FIG. 13 is a front view of the present invention in the alternative embodiment, showing the plurality of fastener openings traversing through the back panel.

FIG. 14 is a rear view of the present invention in the alternative embodiment, showing the plurality of fastener openings traversing through the back panel.

### DETAIL DESCRIPTIONS OF THE INVENTION

All illustrations of the drawings are for the purpose of describing selected versions of the present invention and are not intended to limit the scope of the present invention.

Before explaining at least one embodiment of the present invention in detail, it is to be understood that the device is not limited in its application to the details of the components and arrangements as described or illustrated. The present invention is capable of other embodiments and of being utilized and carried out in various ways. It is also to be understood that the phrasing and terminology employed herein are for the purpose of description and should not be regarded as limiting. As such, the present invention is primarily attached to automobile bumpers, trunks, sides of cars, refrigerators, and other magnetic surfaces, however, the device may be applied to many other settings, situations, and scenarios.

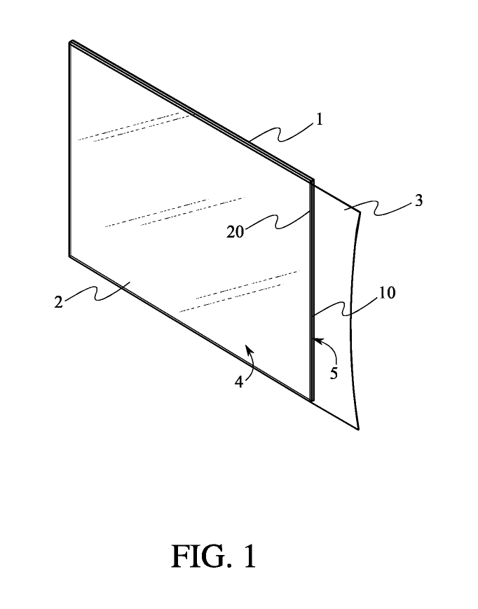

In view of the aforementioned problem(s), the present invention is an envelope for interchangeable display inserts. In reference to FIG. 1-3, the present invention comprises a back panel 1, a front cover 2, and a flap 3 that form an envelope like structure for housing and protecting a display insert 6. The front cover 2 is perimetrically connected to the back panel 1 to form a pocket 4 into which the display insert 6 is positioned. Ideally, the perimeter of the pocket 4 is only slightly larger than the perimeter of the display insert 6. This allows the display insert 6 to be easily positioned into and removed from the pocket 4, while preventing the display insert 6 from sliding into an undesired orientation within the pocket 4. This ensures the display insert 6 is always properly oriented to be viewed correctly by others.

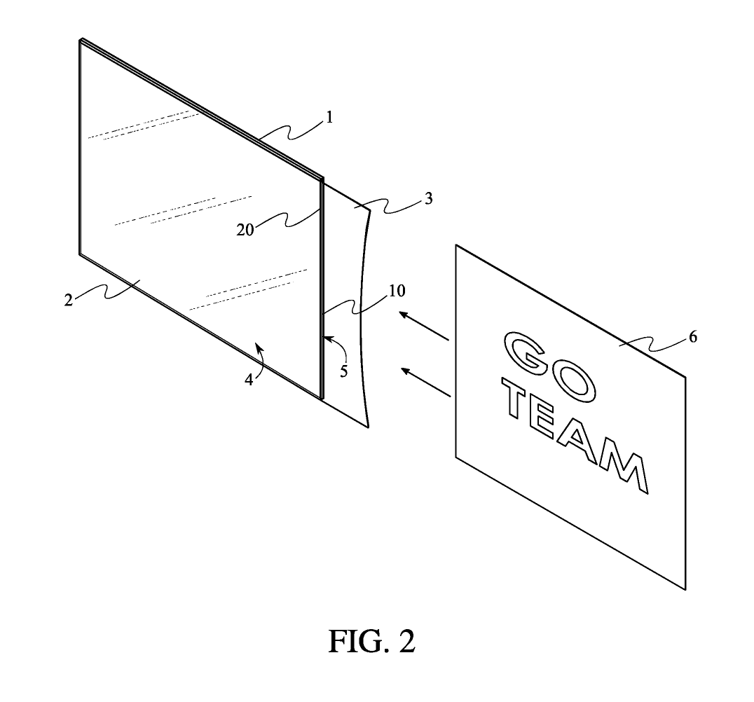

In reference to FIG. 1-2, the front cover 2 comprises a non-affixed front edge 20, while the back panel 1 comprises a non-affixed back edge 10. The non-affixed front edge 20 is detached from the non-affixed back edge 10 to form an opening 5 into the pocket 4. The non-affixed front edge 20 is aligned with the non-affixed back edge 10, such that the opening 5 is formed about one side or portion of the pocket 4. The opening 5 allows the display insert 6 to be positioned into or removed from the pocket 4. As such, the opening 5 is slightly larger than the display insert 6, to allow the display insert 6 to pass into and out of the pocket 4 with minimal interference.

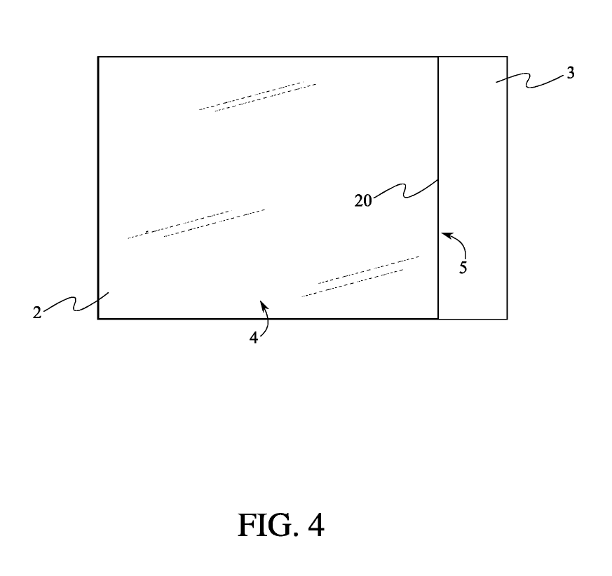

In reference to FIG. 4, the flap 3 is adjacently connected to the front cover 2 along the non-affixed front edge 20, wherein the flap 3 is able to freely pivot about the non-affixed front edge 20. The flap 3 provides a means for sealing the pocket 4 and the opening 5 closed in order to prevent the display insert 6 from inadvertently falling out and to protect the display insert 6 from environmental elements such as rain. In some embodiments a fastening mechanism may be integrated with the flap 3 and either the back panel 1 or the front cover 2 in order to secure the flap 3 in a closed position.

The back panel 1 provides a mounting surface for securing the present invention to a surface. Meanwhile, the front cover 2 is transparent such that the display insert 6 is visible to onlookers when the present invention is mounted to the desired surface. Preferably, the flap 3 and the front cover 2 are constructed from a single piece of material, wherein the flap 3 is also transparent. However, the flap 3 may be transparent or opaque.

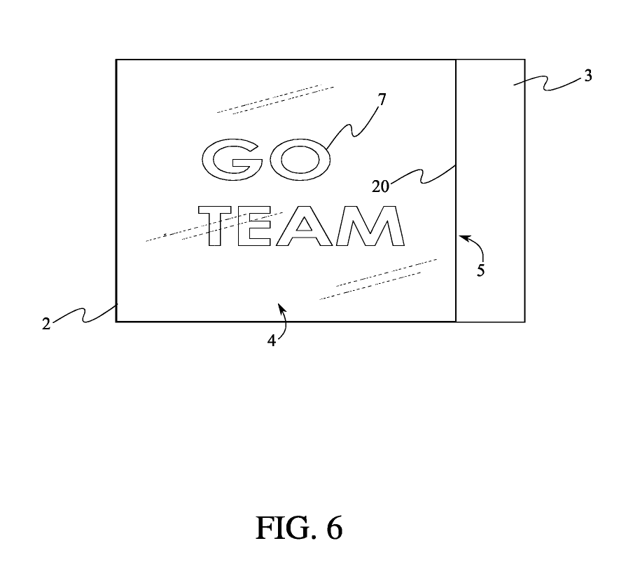

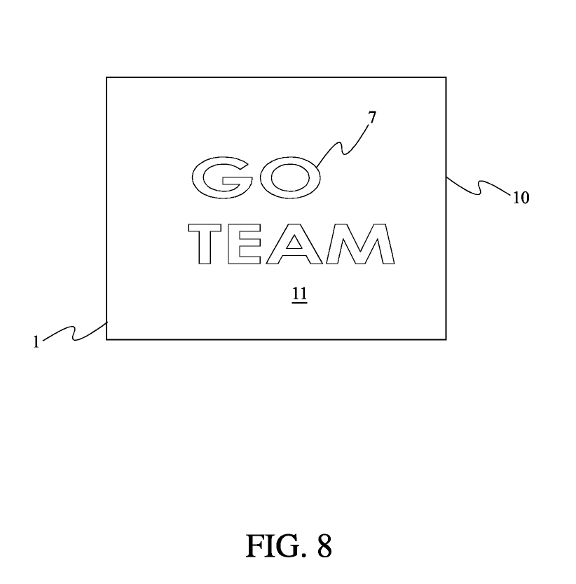

In reference to FIG. 6 and FIG. 8, in some embodiments, the present invention may further comprise a display image 7. The display image 7 is positioned on the back panel 1, adjacent to the front cover 2. In this way, the display image 7 is visible to onlookers when the display insert 6 is removed from the pocket 4. This allows the present invention to be used as a decorative item even without the use of the display insert 6. The display image 7 may printed onto the back panel 1, embossed on the back panel 1, or oriented on the back panel 1 in any other manner.

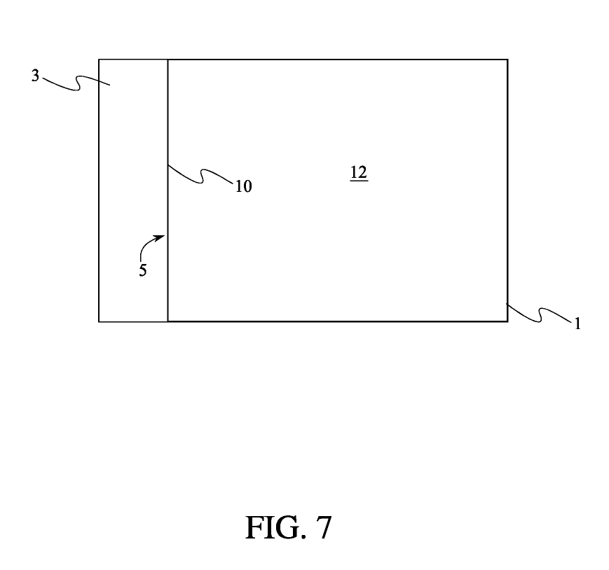

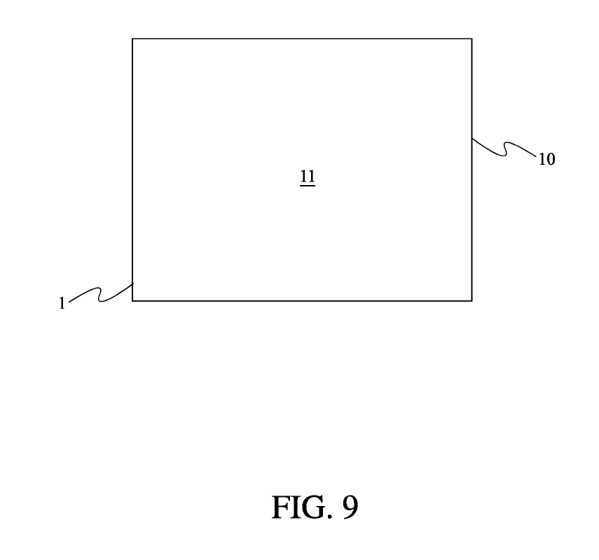

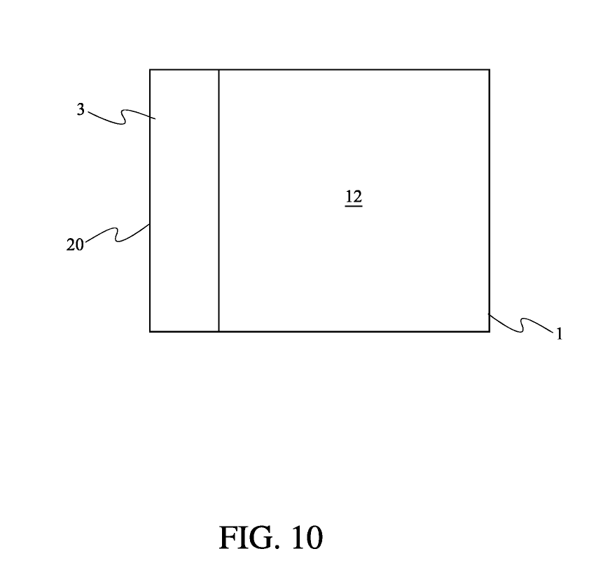

In the preferred embodiment of the present invention, the back panel 1 is magnetic, such that the present invention can be attached to a metal object, such as a car. More specifically, the back panel 1 comprises an inner surface 11, depicted in FIG. 8-9, and an outer surface 12, depicted in FIG. 7 and FIG. 10. The inner surface 11 is non-magnetic, while the outer surface 12 is magnetic. This allows the present invention to be secured to the desired metal surface, while also allowing the display insert 6 to be a metal object. Because the inner surface 11 is non-magnetic, if the display insert 6 is metal or has metal components, the display insert 6 can still be positioned into the pocket 4 unimpeded.

Preferably, the back panel 1 and the front cover 2 are flexible. The flexible nature of the back panel 1 and the front cover 2 allows opposing edges of both the back panel 1 and the front cover 2 to be squeezed together to manipulate the opening 5 and the pocket 4 to more easily position the display insert 6 inside the pocket 4. Furthermore, the flexible nature of the back panel 1 and the front cover 2 allows the present invention to conform to the shape of the surface to which the present invention is being attached. For example, most car bumpers are not perfectly flat, thus the flexible nature allows the back panel 1 and the front cover 2 to conform to the slight curvature of the car bumper.

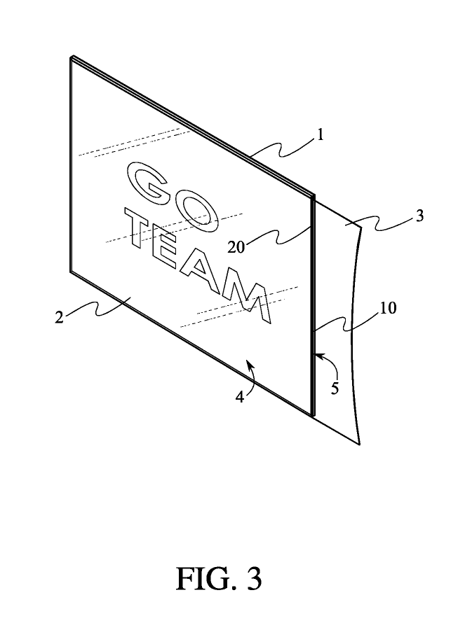

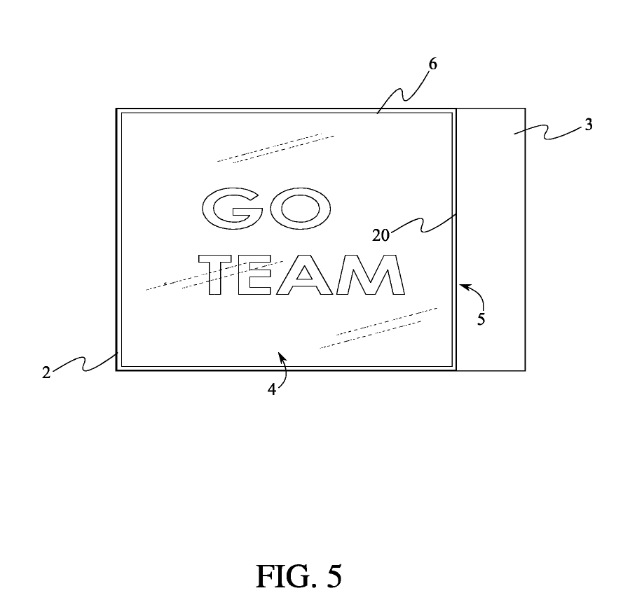

In the preferred embodiment of the present invention, the back panel 1 is a rectangular magnetic panel with a non-magnetic backing, while the front cover 2 is a clear panel made from a clear plastic film which covers the non-magnetic backing. All but one of the edges of the front cover 2 is affixed to a corresponding edge of the back panel 1; the non-affixed front edge 20 and the non-affixed back edge 10 forming the opening 5 which leads into the pocket 4, or space, between the clear panel and the non-magnetic backing of the magnetic panel. The display insert 6 may be placed inside the pocket 4 in order to show a message, symbols, and/or other design through the clear panel, as depicted in FIG. 3 and FIG. 5. The display insert 6 may be selected from a plurality of display inserts, wherein each of the plurality of display inserts presents a unique display.

In the preferred embodiment, the present invention acts as a magnetic envelope with a clear plastic film that holds and presents the display insert 6; the display insert 6 being paper or another similarly thin object. The non-magnetic backing of the magnetic panel can also be personalized with the display image 7, as depicted in FIG. 6, to include branding of a company, a message, or other designs that can be easily viewed through the clear panel when the display insert 6 is not in use.

In the preferred embodiment of the present invention, the envelope formed by the front cover 2 and the back panel 1 is rectangular in shape. While the magnetic panel and clear panel are generally rectangular, the envelope may be formed in any size. For the purpose of simplicity in description, the magnetic panel and clear panel will herein be described as comprising a rectangular shape, in which the length of the front cover 2 and the back panel 1 is greater than or equal to the width of the front cover 2 and the back panel 1, respectively. However, in other embodiments of the present invention, the front cover 2 and the back panel 1 may be any other desired shape.

In the preferred embodiment of the present invention, the magnetic panel is thin, durable, and slightly flexible. The magnetic panel comprises a magnetic side (the outer surface 12) and a non-magnetic side (the inner surface 11). The clear panel is thin and flexible, being made out of a see-through plastic film, and is formed by the front cover 2 and the flap 3. The magnetic panel and clear panel are approximately even in width, however, the length of the clear panel exceeds the magnetic panel by approximately 10-20% or more. More specifically, the flap 3 forms the portion of the clear panel that exceeds past the magnetic panel. In this way, the flap 3 can be folded behind the magnetic panel, as depicted in FIG. 10, in order to secure the pocket 4 and the opening 5 closed.

In the preferred embodiment of the present invention, the back panel 1 and the front cover 2 each comprise a first edge, a second edge, a third edge, and a fourth edge. The first edge and the third edge of the back panel 1 are parallel to each other, delineating the length of the back panel 1. Meanwhile, the second edge and the fourth edge of the back panel 1 are parallel to each other, delineating the width of the back panel 1, wherein the second edge and the fourth edge of the back panel 1 are both perpendicular to the first edge and the third edge of the back panel 1.

Similar to the back panel 1, the first edge and the third edge of the front cover 2 are parallel to each other and delineate the length of the front cover 2. Meanwhile, the second edge and the fourth edge of the front cover 2 are parallel to each other and delineate the width of the front cover 2, wherein the second edge and the fourth edge of the front cover 2 are perpendicular to the first edge and the third edge of the front cover 2. The clear panel is laid against the non-magnetic backing (the inner surface 11) of the magnetic panel, wherein the clear panel and the magnetic panel are connected as follows: the first edge of the front cover 2 is affixed to the first edge of the back panel 1; the second edge of the front cover 2 is affixed to the second edge of the back panel 1; and the third edge of the front cover 2 is affixed to the third edge of the back panel 1. The aforementioned edges may be affixed via stitching/micro-stitching, adhesive connection, heat sealing, or other means well known and understood by those skilled in the art and sciences of related manufacturing industries.

Meanwhile, the fourth edge of the front cover 2 and the fourth edge of the back panel 1 are not affixed to one another. Thus, the fourth edge of the front cover 2 forms the non-affixed front edge 20, while the fourth edge of the back panel 1 forms the non-affixed back edge 10. The flexible nature of the front cover 2 and the back panel 1 allows the fourth edge of the front cover 2 and the fourth edge of the back panel 1 to be offset from each other, thus forming the opening 5 through which the display insert 6 is positioned into the pocket 4. The flap 3 is hingedly connected along the fourth edge of the front cover 2, wherein the flap 3 is free-moving. The flap 3 can be positioned about the opening 5 to secure the display insert 6 within the pocket 4.

In the preferred embodiment of the present invention, the pocket 4 is the space in between the front cover 2 of the clear panel and the inner surface 11, or non-magnetic backing, of the magnetic panel. The pocket 4 is used to receive one of the plurality of display inserts that is selected by the user. Each of the plurality of display inserts is a generally thin piece of paper, or similarly thin object, that may be slid through the opening 5 and fitted into the pocket 4. Each of the plurality of display inserts comprises a display message, symbol, and/or design on one or both of its sides. When slid into the pocket 4, the display message will face towards the clear panel, allowing individuals to easily view the display message. Once the display insert 6 is positioned within the pocket 4, the flap 3 may be folded around the fourth edge of the magnetic panel in order to close the pocket 4, thus forming a water proof barrier. When the present invention is placed on a metal object, the flap 3 is clamped in place between the magnetic panel and the metal object by the magnetic force of the back panel 1.

In the preferred embodiment of the present invention, the envelope may be connected to a metal surface, by placing the outer surface 12 of the magnetic panel, which is magnetic, against the metal object. The envelope may be easily peeled off the metal surface for removal, without damaging the metal surface. The display insert 6 may be placed inside the pocket 4 and the flap 3 may be folded over the opening 5, pressing the flap 3 against a portion of the outer surface 12 of the magnetic panel, before attaching the envelope to the metal surface. With this, the flap 3 functions to hold the display insert 6 in place, preventing the display insert 6 from falling out of the envelope in unwanted circumstances, while also acting as a waterproof barrier to protect the display insert 6.

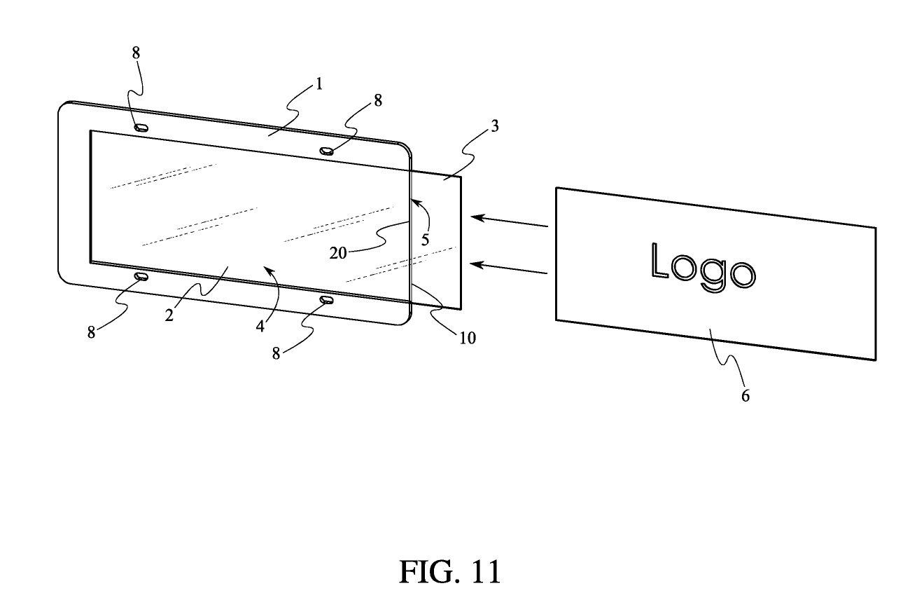

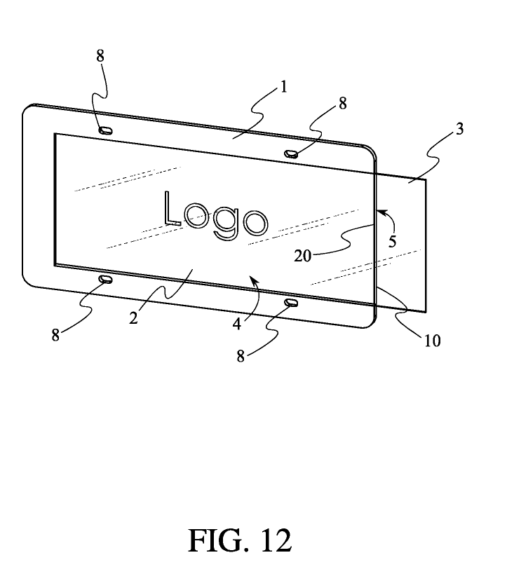

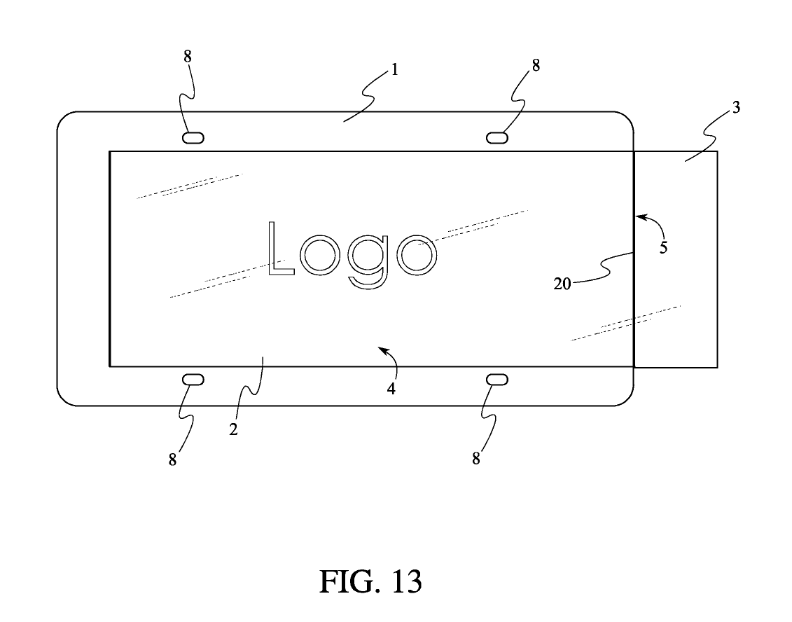

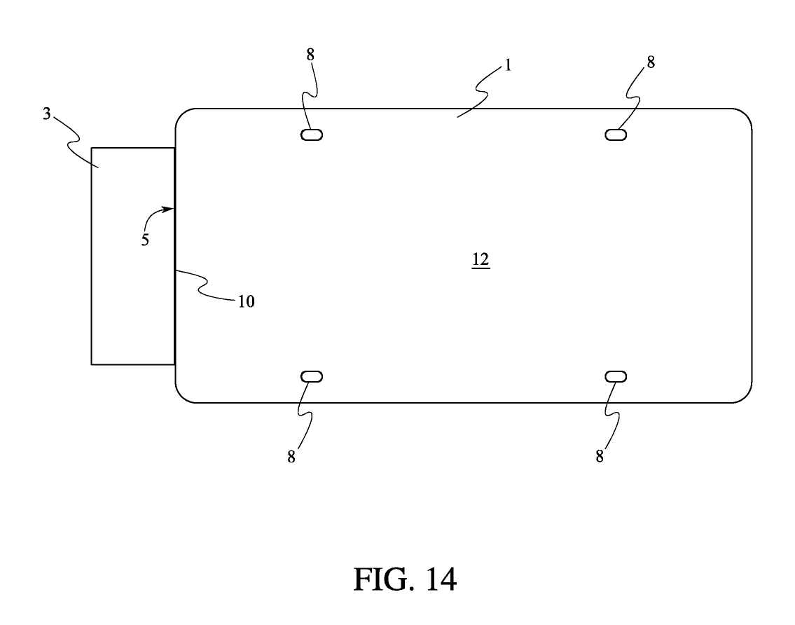

In reference to FIG. 11-14, in some embodiments of the present invention, the back panel 1 is not magnetic and the present invention further comprises a plurality of fastener openings 8. Each of the plurality of fastener openings 8 traverses through the back panel 1, such that a corresponding fastener may be positioned through each of the plurality of fastener openings 8 in order to secure the present invention to the desired surface. The plurality of fastener openings 8 may be distributed about the back panel 1 in any matter, so as to allow the present invention to be attached to the desired object. The placement of each of the plurality of fastener openings 8 may correspond to already existing mounting points on another object, for example the mounting points of a license plate.

In further reference to FIG. 11-14, in an alternative embodiment of the present invention, the present invention is a license plate display for interchangeable display inserts. In the alternative embodiment, the present invention comprises a main body formed by the front cover 2 and the back panel 1, the display insert 6, and the plurality of fastener openings 8. The main body may be any shape and size though the main body is preferably the shape and size of standard license plates. The main body may be constructed from any material, such as metal. The front cover 2 is positioned at the front of the main body, wherein the front cover 2 is formed from a transparent, rigid material such as hard clear plastic. The main body is rectangular is shape, wherein the opening 5 is positioned at the right side of the main body; though the opening 5 may also be positioned at the left side of the main body. The opening 5 may be any shape and size, though the opening 5 must be shaped and sized larger or equal to the side face of the display insert 6.

The opening 5 leads to the pocket 4, which is the recessed space formed between the front cover 2 and the back panel 1 of the metal main body. The pocket 4 is able to receive the display insert 6 through the opening 5. The front cover 2 is transparent to allow people to view the display insert 6 disposed inside the pocket 4 of the main body. The flap 3 is positioned at the side of the main body where the opening 5 is positioned. The flap 3 is composed of a soft flexible material such as plastic. The flap 3 is an extension from the front cover 2 and extends away from the main body. The flap 3 is connected along the non-affixed front edge 20 of the front cover 2 where the opening 5 is formed.

The plurality of fastener openings 8 is distributed about the main body, providing multiple points for mounting the present invention. In the alternative embodiment of the present invention, the plurality of fastener openings 8 is positioned in the same location as the fastener holes on a standard license plate. In the alternative embodiments of the present invention, each of the plurality of fastener openings 8 is shaped to receive a screw or bolt. However, each of the plurality of fastener openings 8 may be any shape and size in other embodiments of the present invention, in order to receive fasteners other than screws and bolts. The main body may be secured to the front or rear bumper of a vehicle through the plurality of fastener openings 8 and a plurality of fasteners, such as screws or bolts.

The display insert 6 is a license plate, or similarly thin object, that may be slid through the opening 5 and fitted into the pocket 4. The display insert 6 may be a registered license plate, or an ornamental license plate that comprises a display message, symbol, and/or design on one or both sides. Once the display insert 6 is positioned within the pocket 4, the flap 3 may be folded over the opening 5 to cover and hold the display insert 6 in place inside the pocket 4. The present invention may further include a securing device used to secure the flap 3 in the closed position.

The securing device may be any type of fastening mechanism such as a hook and loop fastener, a snap fastener, an adhesive fastener, or other fastening device able to secure the flap 3 onto the main body when the flap 3 is folded over the opening 5. The securing device may provide an interface between the flap 3 and either the front cover 2 or the back panel 1. In one embodiment of the present invention, the securing device includes a female fastener that is positioned within the pocket 4 near the opening 5 and is connected to the inner surface 11 of the back panel 1. The securing device further includes a male fastener that is integrated with the flap 3. In this way, the flap 3 may be folded and inserted into the pocket 4 between the display insert 6 and the back panel 1, wherein the flap 3 is secured in place by connecting the male fastener to the female fastener. The flap 3 acts as a waterproof barrier to protect the display insert 6 from environmental conditions such as rain and snow.

Although the invention has been explained in relation to its preferred embodiment, it is to be understood that many other possible modifications and variations can be made without departing from the spirit and scope of the invention as hereinafter claimed.

What is claimed is:

1. An envelope for interchangeable display inserts comprises:
a back panel comprising a non-affixed back edge;
a front cover comprising a non-affixed front edge;
a flap;
the front cover being transparent;
the front cover being perimetrically connected to the back panel to form a pocket;
the non-affixed front edge being aligned with the non-affixed back edge;
the non-affixed front edge being detached from the non-affixed back edge to form an opening into the pocket; and
the flap being adjacently connected to the front cover along the non-affixed front edge.

2. The envelope for interchangeable display inserts as claimed in claim 1 comprises:
the back panel being magnetic.

3. The envelope for interchangeable display inserts as claimed in claim 2 comprises:
the back panel comprising an inner surface and an outer surface;
the inner surface being non-magnetic; and
the outer surface being magnetic.

4. The envelope for interchangeable display inserts as claimed in claim 1 comprises:
the back panel being flexible.

5. The envelope for interchangeable display inserts as claimed in claim 1 comprises:
the front cover being flexible.

6. The envelope for interchangeable display inserts as claimed in claim 1 comprises:
a display image; and
the display image being positioned on the back panel, adjacent to the front cover.

7. The envelope for interchangeable display inserts as claimed in claim 1 comprises:
a display insert; and
the display insert being positioned in the pocket.

8. The envelope for interchangeable display inserts as claimed in claim 7 comprises:
the flap being folded around the back panel.

9. The envelope for interchangeable display inserts as claimed in claim 1 comprises:
a plurality of fastener openings; and
the plurality of fastener openings traversing through the back panel.
